(19) United States
(12) Patent Application Publication
(10) Pub. No.: US 2016/0079050 A1
(43) Pub. Date: Mar. 17, 2016

(54) MASS SPECTROMETRY METHOD, ION GENERATOR AND MASS SPECTROMETRY SYSTEM

(71) Applicants: SHISEIDO COMPANY, LTD., Tokyo (JP); BIO CHROMATO, INC., Kanagawa (JP)

(72) Inventors: Haruo SHIMADA, Kanagawa (JP); Yuka MORISHITA, Kanagawa (JP); Yoshimasa NAKATANI, Kanagawa (JP); Kazumasa KINOSHITA, Kanagawa (JP); Yasuo SHIDA, Tokyo (JP)

(21) Appl. No.: 14/784,611

(22) PCT Filed: Apr. 14, 2014
(86) PCT No.: PCT/JP2014/060645

§ 371 Date: Oct. 15, 2015

(30) Foreign Application Priority Data
Apr. 16, 2013 (JP) 2013-085930

(51) Int. Cl. H01J 49/04; H01J 49/00; H01J 49/10

(52) U.S. Cl. CPC H01J 49/0454; H01J 49/102; H01J 49/0031

(57) ABSTRACT

A mass spectrometry method includes a step of atomizing liquid including a sample using an ultrasonic transducer; a step of transferring the atomized liquid; a step of generating ions from the transferred liquid using a DART ion source; and a step of analyzing a mass spectrometry by introducing the generated ions into a mass spectrometer.

### BACKGROUND OF THE INVENTION

1. Field of the Invention

The present invention relates to a mass spectrometry method, an ion generator and a mass spectrometry system.

2. Description of the Related Art

Although various methods are known as an atmospheric pressure ionization method, Direct Analysis in Real Time (DART) has been focused on, recently.

The DART is a method in which atoms or molecules at an electronic excited state are collided with water in air to generate protons by penning ionization and the protons are added to a sample for ionization. For example, a sample M can be ionized as follows in the case of using helium at a metastable excited state as “He(2³S)”.

He(2³S)+H₂O→H₂O⁺*+He(1¹S)+e⁻

H₂O⁺*+H₂O→H₃O⁺+OH*

H₃O⁺+nH₂O→[(H₂O)ₙH]⁺

[(H₂O)ₙH]⁺+M→MH⁺+nH₂O

Patent document 1 discloses a mass spectrometry method in which a sample is heated to generate gas, and using the DART, ions generated from the gas are introduced into a mass spectrometer to analyze a mass spectrometry.

### Patent Document

### [Patent Document 1] WO2012/090915

However, thermal decomposition may be occurred occasionally, so that it is desired to suppress thermal decomposition of the sample when performing an atomizing step of the sample.

### SUMMARY OF THE INVENTION

The present invention is made considering to solve the above problems, and provides a new mass spectrometry method and an ion generator capable of suppressing thermal decomposition when atomizing a sample.

According to an embodiment, there is provided a mass spectrometry method including a step of atomizing liquid including a sample using an ultrasonic transducer; a step of transferring the atomized liquid; a step of generating ions from the transferred liquid using a DART ion source; and a step of analyzing a mass spectrometry by introducing the generated ions into a mass spectrometer.

According to an embodiment, there is provided an ion generator including an atomizing unit that atomizes liquid including a sample using an ultrasonic transducer;

a transferring unit that transfers the atomized liquid; and a DART ion source that generates ions from the transferred liquid.

According to the embodiments, a mass spectrometry method and an ion generator capable of suppressing thermal decomposition when atomizing a sample can be provided.

### BRIEF DESCRIPTION OF THE DRAWINGS

FIG. 1 is a schematic view illustrating an example of a mass spectrometry system;

FIG. 2 is a schematic view illustrating an example of a method of heating a tube of FIG. 1;

FIG. 3 is a schematic view illustrating a method of suppressing mixing of liquid that is not atomized;

FIG. 4 is a schematic view illustrating another example of the mass spectrometry system;

FIG. 5 is a mass spectrum of glycyrrhizinic acid of Example 1;

FIG. 6 is a schematic view illustrating a mass spectrometry method of comparative example 1;

FIG. 7 is a mass spectrum of glycyrrhizinic acid of comparative example 1;

FIG. 8 is a view for explaining thermal decomposition of glycyrrhizinic acid; and

FIG. 9 is a mass spectrum of comparative example 2.

### DETAILED DESCRIPTION OF THE PREFERRED EMBODIMENTS

Next, the invention will be described herein with reference to illustrative embodiments.

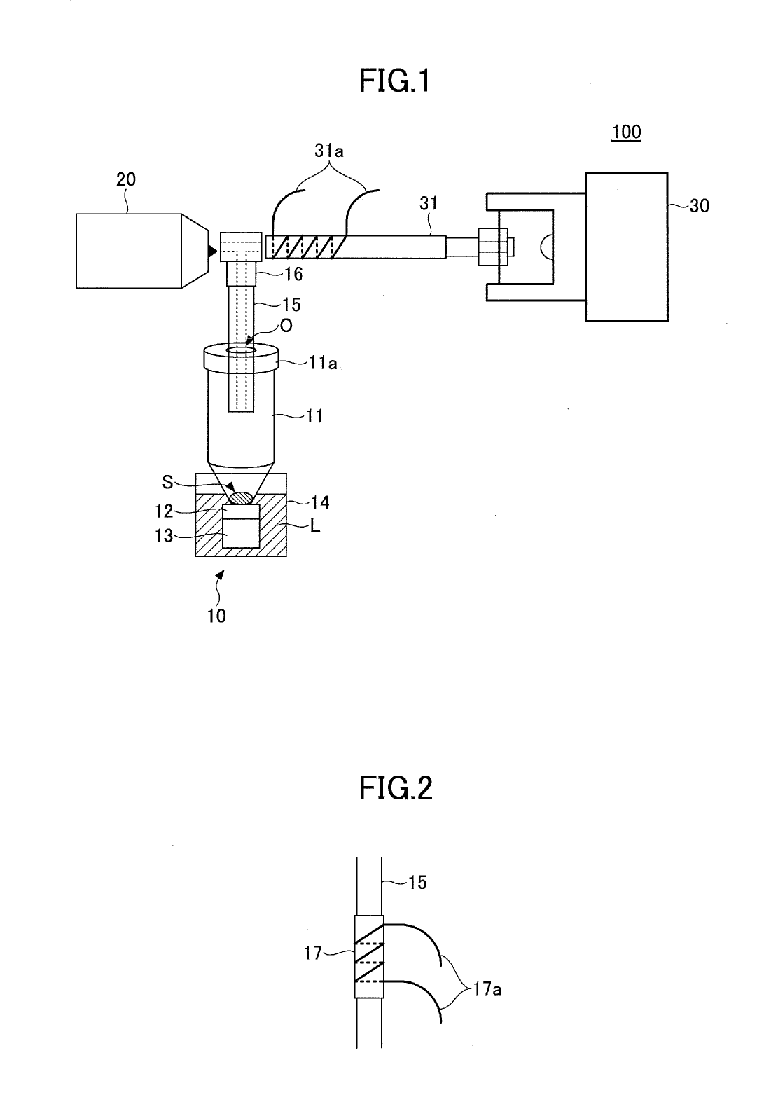

FIG. 1 illustrates an example of a mass spectrometry system.

A mass spectrometry system 100 includes an ultrasonic atomizer 10, a DART ion source 20 and a mass spectrometer 30.

Then, a mass spectrometry method using the mass spectrometry system 100 is explained.

First, after introducing 0.3 to 10 mL of sample solution S in a tube 11 with a cap, the tube 11 with a cap is held by a holding member 12. At this time, the holding member 12 is fixed on an ultrasonic transducer 13 in a container 14 in which liquid L is introduced, and the tube 11 with a cap is held such that to contact with the liquid L. Thus, the sample solution S can be atomized by applying voltage to the ultrasonic transducer 13 using a power source (not illustrated in the drawings). Further, a cap 11a of the tube 11 with a cap is provided with an open portion O and a tube 15 is inserted in the open portion O. Thus, the atomized sample solution S is transferred in the tube 15. Further, a three way cock 16 is provided at an outlet port side of the tube 15.

The oscillation frequency of the ultrasonic transducer 13 is, generally, 10 kHz to 10 MHz and is preferably, 100 kHz to 3 MHz.

As the ultrasonic transducer 13, not specifically limited, piezoelectric ceramics or the like may be used.

The inner diameter of the tube 15 is, generally, 5 to 20 mm.

The length of the tube 15 is, generally, 0.05 to 2 m.

Fluororesin, polyether ether ketone, silicone resin or the like may be coated on an inner wall of the tube 15.

A heating tube 17 may be attached at an outer surface of the tube 15 (see FIG. 2). At this time, as a resistor heating line 17a is wound around the heating tube 17, the heating tube 17 can be heated by applying voltage to the resistor heating line 17a using a power source (not illustrated in the drawings). With this, adhesion of the atomized sample solution S to the tube 15 can be suppressed.

Here, as the atomized sample solution S tends to adhere to a side of the tube 15 where the atomized sample solution S is introduced, generally, it is preferable that the heating tube 17 is attached to the side of the tube 15 where the atomized sample solution S is introduced.

The temperature of the inner wall of the heating tube 17 when heating the heating tube 17 is, generally, 50 to 400° C., and preferably, 100 to 300° C.

Here, as the method of heating the tube 15, it is not limited to the method of attaching the heating tube 17, and a method of heating using a ceramic fiber heater, a method of heating by irradiating micro-wave, a method of heating using a hot air blower or the like may be used.

As the material composing the heating tube 17, it is not specifically limited as long as having a heat resistance property, and ceramics, a glass, Teflon (registered trademark), a stainless steel, a niobium steel, a tantalum steel or the like may be used.

As the material composing the resistor heating line 17a, not specifically limited, a metal heater element such as an iron-chrome-aluminum based alloy, a nickel-chrome based alloy or the like; a high melting point metal heater element such as platinum, molybdenum, tantalum, tungsten or the like; a non-metal heater element such as silicon carbide, molybdenum-silicide, carbon or the like, or the like may be used.

For example, when a nickel-chromium based alloy (nichrome) wire whose diameter is 0.26 mm is used as the resistor heating line 17a, current of 1 to 6 A is flowed.

Here, when atomizing the sample solution S, it is preferable to suppress mixing of sample solution S that is atomized into the tube 15. With this, ions can be efficiently generated from the sample included in the atomized sample solution S.

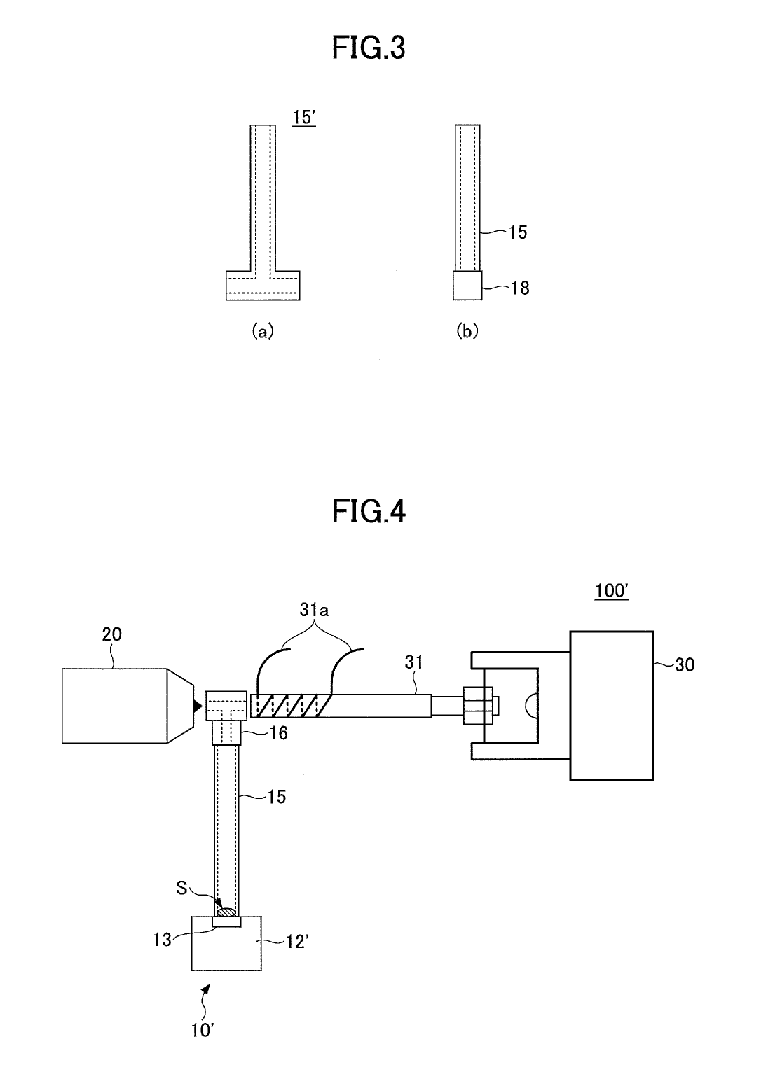

As the method of suppressing mixing of the sample solution S that is not atomized may be, not specifically limited, a method of providing a tube 15′ in which open portions at an inlet port side are formed in a direction substantially perpendicular to a direction at which the atomized sample solution S is generated (see FIG. 3-(a)), a method of providing a filter 18 at an open portion at an inlet port side of the tube 15 (see FIG. 3 (b)) or the like may be used.

The pore size of the filter 18 is, generally, 0.1 to 2 mm.

Next, using the DART ion source 20, helium at a metastable excited state “He(2³S)” is collided with water in air to generate protons by penning ionization, and ions generated by irradiating the protons on the atomized sample solution S in the three way cock 16 are introduced from an ion introduction pipe 31 of the mass spectrometer 30 to analyze a mass spectrometry. At this time, the inside of the ion introduction pipe 31 is decompressed by a compressor (not illustrated in the drawings). With this, the ions generated from the sample included in the atomized sample solution S are introduced into the mass spectrometer 30.

The temperature of a gas heater of the DART ion source 20 is, generally, room temperature to 200° C., and preferably, room temperature to 100° C. When the temperature of the gas heater of the DART ion source 20 exceeds 200° C., the sample may be thermally decomposed.

At this time, as a resistor heating line 31a is wound around the ion introduction pipe 31 of the mass spectrometer 30, the mass spectrometry of the ions generated from the sample can be analyzed by heating the ion introduction pipe 31 by applying voltage to the resistor heating line 31a using a power source (not illustrated in the drawings). With this, adhesion of the ions generated from the sample to the ion introduction pipe 31 can be suppressed.

Here, as the ions generated from the sample tends to adhere to a side of the ion introduction pipe 31 where the ions generated from the sample are introduced, generally, it is preferable that the resistor heating line 31a is wound around at the side of the ion introduction pipe 31 where the ions generated from the sample are introduced.

The temperature of the inner wall of the ion introduction pipe 31 when heating the ion introduction pipe 31 is, generally, 50 to 400° C., and preferably, 100 to 300° C.

Here, as the method of heating the ion introduction pipe 31, it is not limited to the method of winding the resistor heating line 31a, and a method of heating using a ceramic fiber heater, a method of heating by irradiating micro-wave, a method of heating using a hot air blower or the like may be used.

Further, the ion introduction port may be directly heated by detaching the ion introduction pipe 31.

Further, when the ions generated in the ion introduction pipe 31 hardly adhere, the ion introduction pipe 31 may not be heated.

As the material for composing the ion introduction pipe 31, it is not specifically limited as long as having a heat resistance property, and ceramics, a glass, Teflon (registered trademark), a stainless steel, a niobium steel, a tantalum steel or the like may be used.

Fluororesin, polyether ether ketone, silicone resin or the like may be coated on an inner wall of the ion introduction pipe 31.

As the material composing the resistor heating line 31a, not specifically limited, a metal heater element such as an iron-chromium-aluminum based alloy, a nickel-chromium based alloy or the like; a high melting point metal heater element such as platinum, molybdenum, tantalum, tungsten or the like; a non-metal heater element such as silicon carbide, molybdenum-silicide, carbon or the like, or the like may be used.

For example, when a nichrome wire whose diameter is 0.26 mm is used as the resistor heating line 31a, current of 1 to 6 A is flowed.

As the sample, it is not specifically limited as long as it is possible to generate ions using the DART ion source 20, and an organic compound, a high molecular compound or the like may be used.

As the solvent included in the sample solution S, not specifically limited, water, methanol, ethanol, acetonitrile or the like may be used, and two or more of them may be used together.

Moreover, sample dispersion (or suspension) may be used instead of the sample solution S.

As dispersion (or suspension) medium included in the sample dispersion, not specifically limited, water, methanol, ethanol, acetonitrile or the like may be used, and two or more of them may be used together.

Further, when the sample is liquid, the sample may be used instead of the sample solution S.

As the liquid L, not specifically limited, water or the like may be used.

FIG. 4 illustrates another example of the mass spectrometry system. Here, in FIG. 4, the same components as those of FIG. 1 are given the same reference numerals, and explanations are not repeated.

The mass spectrometry system 100′ has the same structure as the mass spectrometry system 100 except that including an ultrasonic atomizer 10′ instead of the ultrasonic atomizer 10.

Next, a mass spectrometry method using the mass spectrometry system 100′ is explained.

First, 1 to 10 uL of sample solution S is dropped on the ultrasonic transducer 13 that is held by a holding member 12′. With this, by applying voltage to the ultrasonic transducer 13 using a power source (not illustrated in the drawings), the sample solution S can be atomized. Further, the tube 15 is provided around the dropped sample solution S. Thus, the atomized sample solution S is transferred in the tube 15. Further, the three way cock 16 is provided at the outlet port side of the tube 15.

Next, using the DART ion source 20, helium at a metastable excited state “He(2³S)” is collided with water in air to generate protons by penning ionization, and ions generated by irradiating the protons on the atomized sample solution S in the three way cock 16 are introduced from the ion introduction pipe 31 of the mass spectrometer 30 to analyze a mass spectrometry. At this time, the inside of the ion introduction pipe 31 is decompressed by a compressor (not illustrated in the drawings). Accordingly, the ions generated from the sample included in the atomized sample solution S are introduced into the mass spectrometer 30.

Here, instead of the metastable excited state helium He(2³S), metastable excited state neon, metastable excited state argon, metastable excited state nitrogen or the like may be used.

### Example 1

After introducing 100 mL of water, as the liquid L, and an ultrasonic atomization unit M-011 (manufactured by SEIKO GIKEN INC.) including the ultrasonic transducer 13 in a 200 mL beaker, as the container 14, the holding member 12 was fixed such that its height became 30 mm. Next, 500 μL of 0.67 mg/mL solution of glycyrrhizinic acid (solvent: water/acetonitrile=2/1 (volume ratio)), as the sample solution S, was introduced in a 50 mL centrifuge conical tube made of plastic (manufactured by Corning Incorporated), as the tube 11 with a cap. At this time, an open portion O whose inner diameter was 8 mm was formed in the cap 11a of the centrifuge tube and the tube 15 whose inner diameter was 6 mm and length was 150 mm was inserted therethrough. Further, the three way cock 16 was provided at the outlet port side of the tube 15 (see FIG. 1).

Next, the mass spectrometry of the ions generated from the atomized sample solution S were analyzed using the mass spectrometry system 100. Specifically, first, using the DART ion source 20, helium at a metastable excited state “He(2³S)” was collided with water in air to generate protons by penning ionization, and ions generated by irradiating the protons on the atomized sample solution S were introduced into the mass spectrometer 30 to analyze a mass spectrometry. At this time, the temperature of the inner wall of the ion introduction pipe 31 was 150° C. by heating the ion introduction pipe 31 by flowing current of 4 A through the resistor heating line 31a.

Here, DART SVP (manufactured by IonSense Inc.) was used as the DART ion source 20, and the temperature of the gas heater was 50° C. Further, micrO-TOFQII (manufactured by Bruker Daltonics K.K.) was used as the mass spectrometer 30, and the measurement mode was set at a negative ion mode. Further, a tube made of ceramics with an outer diameter of 6.2 mm, an inner diameter of 4.7 mm and a length of 94 mm was used as the ion introduction pipe 31, and the resistor heating line 31a was wound around at a region from the side at which the ions were introduced for 35 mm. At this time, a nichrome wire whose diameter was 0.26 mm was used as the resistor heating line 31a.

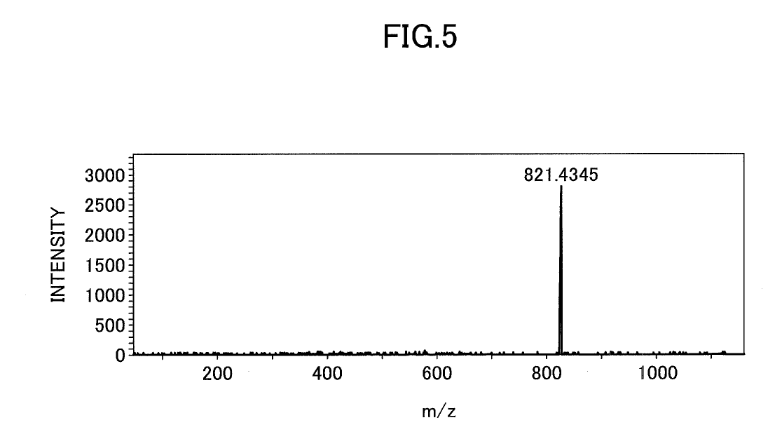

FIG. 5 illustrates a mass spectrum of glycyrrhizinic acid.

From FIG. 5, while a molecular ion peak of glycyrrhizinic acid ([M-H]⁻) whose m/z is 821 is observed, a peak resulted from a thermal decomposition product of glycyrrhizinic acid is not observed, and it can be understood that thermal decomposition could be suppressed and a structure of glycyrrhizinic acid was analyzed.

### Comparative Example 1

A glass rod R was immersed in 0.67 mg/mL solution of glycyrrhizinic acid (solvent: water/acetonitrile=2/1 (volume ratio)) to adhere glycyrrhizinic acid to the glass rod R.

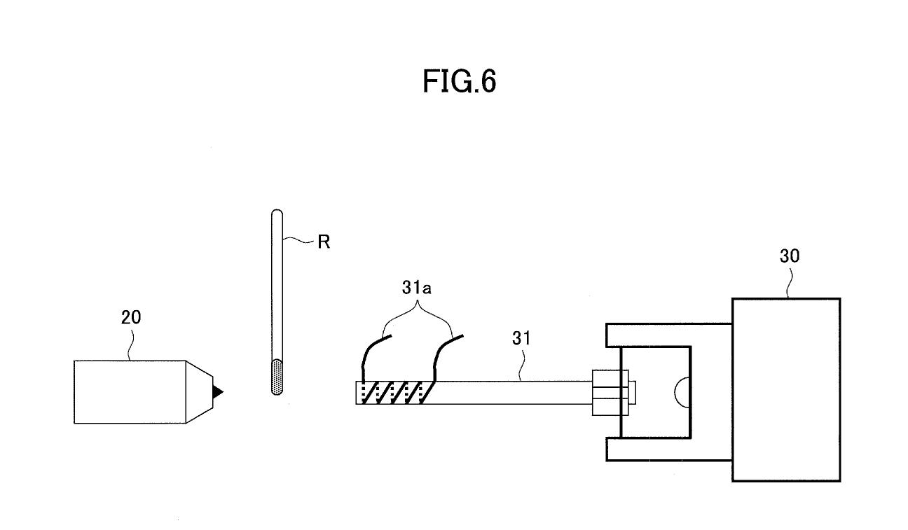

A mass spectrometry was analyzed similarly as Example 1 except that the glass rod R to which glycyrrhizinic acid was adhered was used instead of the ultrasonic atomizer 10, and the temperature of the gas heater was changed to 450° C. (see FIG. 6).

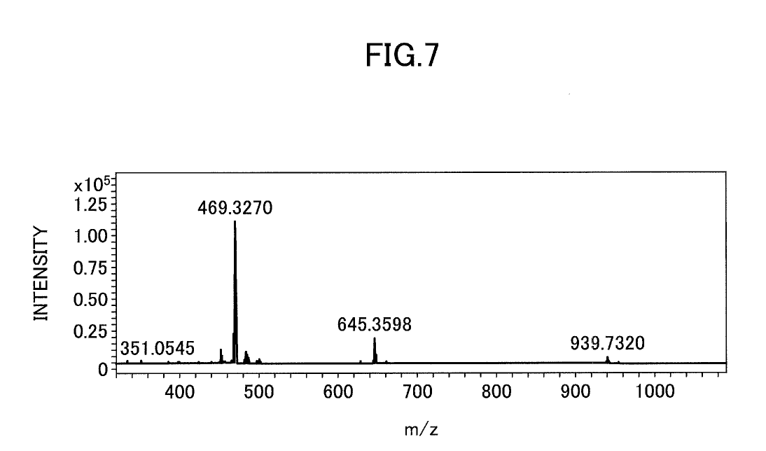

FIG. 7 illustrates a mass spectrum of glycyrrhizinic acid.

From FIG. 7, while a molecular ion peak of glycyrrhizinic acid ([M-H]⁻) whose m/z is 821 is not observed, a peak resulted from a thermal decomposition product of glycyrrhizinic acid is observed, and it can be understood that glycyrrhizinic acid was thermally decomposed.

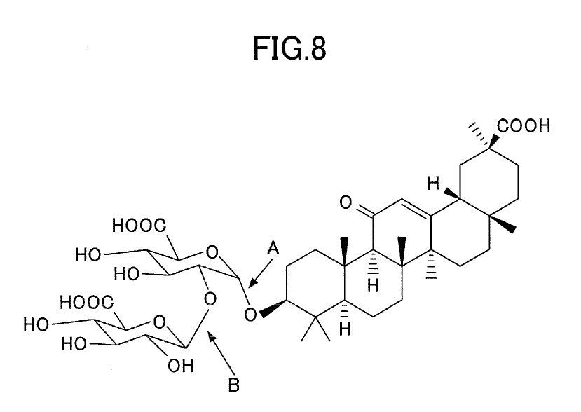

Here, a peak whose m/z is 469 is resulted from a sugar portion that is eliminated when a bond “A” is cut. Further, a peak whose m/z is 645 is resulted from a sugar portion that is eliminated when a bond “B” is cut. Further, a peak whose m/z is 940 is resulted from a dimer of sugar portions eliminated when the bond “A” is cut (see FIG. 8).

### Comparative Example 2

A mass spectrometry was analyzed similarly as comparative example 1 except that the temperature of the gas heater was changed to 50° C.

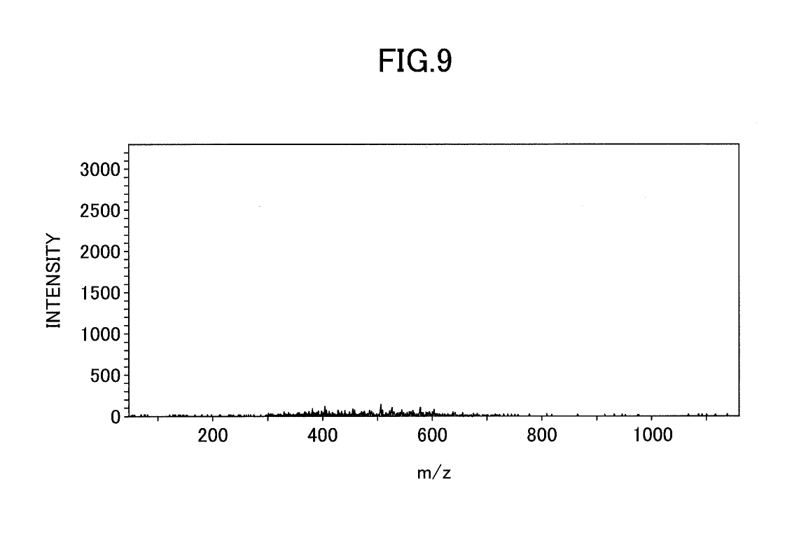

FIG. 9 illustrates a mass spectrum.

From FIG. 9, a molecular ion peak of glycyrrhizinic acid ([M-H]⁻) whose m/z is 821 and a peak resulted from a thermal decomposition product of glycyrrhizinic acid are not observed, and it can be understood that glycyrrhizinic acid was not atomized from the surface of the glass rod R.

The present application is based on and claims the benefit of priority of Japanese Priority Application No. 2013-085930 filed on Apr. 16, 2013, the entire contents of which are hereby incorporated by reference.

### NUMERALS

10, 10′ ultrasonic atomizer

11 tube with a cap

11a cap

12, 12′ holding member

13 ultrasonic transducer

14 container

15, 15′ tube

16 three way cock

17 heating tube

17a resistor heating line

18 filter

20 DART ion source

30 mass spectrometer

31 ion introduction pipe

31a resistor heating line

100, 100′ mass spectrometry system

L liquid

O open portion

S sample solution

What is claimed is:

1. A mass spectrometry method comprising:
a step of atomizing liquid including a sample using an ultrasonic transducer;
a step of transferring the atomized liquid;
a step of generating ions from the transferred liquid using a DART ion source; and
a step of analyzing a mass spectrometry by introducing the generated ions into a mass spectrometer.

2. The mass spectrometry method according to claim 1,
wherein when atomizing the liquid including the sample, mixing of liquid that is not atomized is suppressed.

3. An ion generator comprising:
an atomizing unit that atomizes liquid including a sample using an ultrasonic transducer;
a transferring unit that transfers the atomized liquid; and
a DART ion source that generates ions from the transferred liquid.

4. The ion generator according to claim 3,
wherein the atomizing unit includes a member or a mechanism that suppresses mixing of liquid that is not atomized.

5. A mass spectrometry system comprising:
the ion generator of claim 3; and
a mass spectrometer.
